(19) United States
(12) Patent Application Publication
(10) Pub. No.: US 2014/0287521 A1
(43) Pub. Date: Sep. 25, 2014

(54) Measuring Device for Tubular Bag Packaging Machines

(71) Applicant: WITT GmbH & Co Holding und Handels-KG, Witten (DE)

(72) Inventor: Martin BENDER, Dortmund (DE)

(73) Assignee: WITT GmbH & Co Holding und Handels-KG, Witten (DE)

(21) Appl. No.: 14/206,279

(22) Filed: Mar. 12, 2014

(30) Foreign Application Priority Data
Mar. 13, 2013 (DE) 10 2013 004 292.5

(51) Int. Cl. G01N 21/75

(52) U.S. Cl. CPC G01N 21/75
USPC 436/172; 422/83

(57) ABSTRACT

The invention relates to a measuring device, more particularly for a tubular bag packaging machine 1, to determine the concentration of at least one gas within a package 2 to be sealed, wherein it is possible to introduce a protective gas via a gas lance 3 into the package 2 to be sealed. The measuring device comprises an indicator 4, a light conductor 5, and an evaluation unit 6, wherein the indicator 4 is comprised of a fluorescent material, preferably a polymer material and arranged at the end of the light conductor 5 and within the package 2 to be sealed, wherein the evaluation unit 6 takes-up and evaluates an optical signal from the indicator 4 via the light conductor 5 to determine the concentration of the at least one gas.

The invention relates to a measuring device, more particularly for a tubular bag packaging machine, to determine the concentration of at least one gas within a package to be sealed, wherein it is possible to introduce a protective gas via a gas lance into the package to be sealed.

There are various possibilities for preservation of food, for example pasteurization, irradiation, drying or the use of preservatives. A simple means to preserve foodstuff without adversely affecting or altering the food is packing it in an airtight container in which by addition of protective gases the composition of gases contained therein does not correspond to the standard atmosphere.

Accordingly, it is especially the portion of oxygen within the packaging that is reduced so that, for example, aerobic bacteria cannot proliferate or proliferate only very slowly. Decay of packed foodstuff is thus prevented or accordingly slowed down without affecting quality or taste. The atmosphere within the package is composed, for example, of natural, odorless and taste-neutral constituents of air, e.g. carbon dioxide, nitrogen or oxygen, whose proportions may vary depending on the packed product.

Tubular bag packaging machines with a horizontal forming, filling and sealing system are used for packing of lumpy goods, for example. Accordingly, on the intake of a forming tubular bag, the foodstuff is flushed with a protective gas. To this effect, a gas lance or a flat gassing tube is guided to a point closely in front of a transverse sealing zone, with the air being flushed out, for example, in counter-current to the inflowing stuff.

Tubular bag packaging machines with a vertical forming, filling, and sealing system are utilized, for example, for packing of lumpy or coarse-grained goods. The goods to be packed fall in pre-portioned quantity through a protective gas column and thereby lose the air adhering to the goods. To this effect and in the same way as with the horizontal forming, filling, and sealing system, a gas lance or a thin gassing tube is guided to a point closely in front of the transverse sealing zone.

With the tubular bag packaging machines, it is in any case required to determine the concentration of the protective gas and/or the oxygen concentration within the package. The quality of the package and the durability of the food are thereby ensured.

In prior art, there is the possibility to determine the concentration of the protective gas or oxygen upon sealing the package. Accordingly, it is not possible to determine the concentration during the packaging procedure, and faults or deviations, if any, become evident only after production. This entails high costs due to production rejects on occurrence of faults or deviations. Moreover, the cost spent on determining the concentration of protective gas or oxygen upon sealing the package is too high to execute this constantly.

Furthermore, there is a device known from prior art in which a gas reflux line is provided for at the gas lance, said gas reflux line conducting a small amount of gas existing in the tubular bag to an external measuring sensor system. The gas analysis is performed only with some time lag after the packaging procedure. With a production rate of 60 packages per second, for example, a multitude of packages is produced until the concentration of the protective gas or oxygen is determined. Cost-intensive rejects are produced until a fault is reported or detected.

Now, therefore, it is the object to provide for a measurement of the protective gas or oxygen content within the package at low cost and without or with a slight time lag, if any.

The present invention achieves this object in that the measuring device comprises an indicator, a light conductor, and an evaluation unit, with the indicator being comprised of a fluorescent material, preferably a polymer material, and that it is arranged at the end of the light conductor and within the package to be sealed, with the evaluation unit taking-up and evaluating an optical signal from the indicator via the light conductor in order to determine the concentration of the at least one gas.

A special advantage of the present invention over prior art lies in that the indicator is comprised of a fluorescent material, preferably a polymer material, and arranged at the end of the light conductor and within the package to be sealed, with the evaluation unit taking-up and evaluating an optical signal from the indicator via the light conductor in order to determine the concentration of the at least one gas. In contrast with prior art, it is not necessary to convey any gas from the package to determine the concentration. In accordance with prior art in technology, a time lag that cannot be neglected is caused by the conveyance of gas, as outlined hereinabove. According to the present invention, the concentration of gas is mainly determined in real time. Thus, a quality control can be performed during packing of the goods, and faults or deviations in gas concentration can be detected immediately.

The indicator is preferably comprised of a fluorescent polymer material which just calls for little expenditure on maintenance. Thus the measuring device can be utilized in continuous operation. Costly outage of the tubular bag packaging machine due to maintenance work on the measuring device is thus avoided.

It is of special advantage that the indicator is arranged within the package to be sealed. It is thereby ensured that the measurement is taken at the atmosphere inside the package to be sealed and not outside.

The use of a light conductor furthermore allows for a quick and simple transmission of the optical signal from the indicator to the evaluation unit. For example, the indicator is of such a configuration that the indicator emits a simple optical signal by fluorescence with a suitable concentration of the gas. With this configuration, the evaluation unit merely ascertains the existence of the signal or analyzes the spectrum of fluorescence. To excite the fluorescence, the light from a suitable light source (e.g. a laser diode) can be transmitted via the light conductor to the indicator. Accordingly, the evaluation unit is of an especially simple configuration, and faults or failures are avoided.

In an advantageous embodiment of the present invention, the indicator is subdivided into ranges, wherein each range is sensitive to a certain concentration of a gas. Different ranges of the indicator can thus respond to certain concentrations of the gas, e.g. oxygen or carbon dioxide. Thus, the quality of the package can be better evaluated. For example, this is realized with a subdivision into an ideal, an acceptable, and an unacceptable concentration range. To this effect, the indicator may be comprised of different materials which only produce fluorescence in case of a certain concentration.

Furthermore, it is especially advantageous that ranges of the indicator are sensitive to a concentration of a certain gas. In this configuration of the present invention, the concentrations of several gases can be determined simultaneously with the indicator. For example, it is possible to monitor the concentration of oxygen and nitrogen. Since different foodstuffs require different packaging atmospheres, several gases can be monitored with one indicator according to this embodiment, depending on the goods to be packaged.

Moreover, the tubular bag packaging machine can also be re-equipped in a simple and quick manner, in case that a different packaging atmosphere must be used and monitored. To this effect, the indicator can simply be exchanged.

In another advantageous embodiment of the present invention, it is provided for that the indicator produces fluorescence with a pre-defined partial pressure of the gas to be determined and/or reflects and/or transmits light in a certain wavelength range. Accordingly, the concentration of the gas can be traced back to the partial pressure, and different properties of the indicator can be utilized in order to determine it. Accordingly, the evaluation unit is either passive or active. For example, with a fluorescent indicator, a passive evaluation unit is utilized which takes-up the optical signal from the indicator. On evaluating the reflected and/or transmitted light, the evaluation unit emits light to the indicator via the light conductor and based on the resultant signal it determines the partial pressure and the concentration of the gas to be determined, respectively.

Advantageously, the indicator is of a flat shape and thus just takes little space within the package to be sealed. Thus, also flat packages can be monitored.

Another embodiment of the present invention provides for that the indicator is molded to the light conductor in a form-locking manner. Thus, the optical signal of the indicator can be transmitted in an unadulterated manner.

In an especially advantageous embodiment, the light conductor is guided along the gas lance into the package to be sealed. Accordingly, the indicator is not provided directly at the gas outlet but in staggered arrangement thereto. Thereby it is ensured that in fact the gas existing in the package and, respectively, in the tubular bag rather than the protective gas streaming out from the gas lance is analyzed with regard to the gas composition to be determined.

In one embodiment of the present invention, it is provided for that the light conductor and the indicator are conducted up to a transverse sealing zone of the package to be sealed. Accordingly, the indicator is conducted up to the edge of the package to be sealed in order to ensure that the gas inside the package is analyzed.

In another embodiment of the present invention, it is provided for that a sensor system for temperature recording is provided for, preferably inside the package to be sealed. A conventional thermocouple or a temperature resistor can be implemented. Alternatively, the sensor system may comprise a fluorescent substance. The fluorescent substance has a temperature-dependent fluorescence spectrum. Accordingly, a signal from the sensor system comprises the spectrum emitted from the substance. Thus, the temperature can be determined via the signal from the sensor system. The temperature can be considered in the evaluation unit in the determination of the gas concentration for compensation of temperature dependencies.

In an especially advantageous embodiment, the signal from the sensor system is transmitted together with the signal from the indicator via the light conductor to the evaluation unit, with the evaluation unit evaluating the signals. This enables a simple determination of the temperature within the package to be sealed.

Moreover, the present invention provides for a measuring method, in particular for a tubular bag packaging machine, to determine the concentration of at least one gas within a package to be sealed, according to which a protective gas is introduced via a gas lance into the package to be sealed, characterized in that the gas concentration is indicated via an indicator, and wherein a light conductor is guided into the package to be sealed and an optical signal from the indicator is transmitted via the light conductor to an evaluation unit, with the package being sealed, preferably welded, immediately after transmission of the signal.

In an especially advantageous configuration of the measuring method, it is furthermore provided for that the evaluation unit determines the concentration of the gas from the reflectivity, transmissivity and/or fluorescence of the indicator in a certain optical signal range.

Another embodiment of the measuring method provides for that the concentration of oxygen, nitrogen, carbon dioxide and/or a gas mixture is determined.

In an especially advantageous embodiment of the measuring method, an ambient pressure is determined and utilized for signal compensation. In an advantageous manner, the evaluation unit is utilized for signal compensation. Accordingly, the determination of the pressure is executed in conventional manner, for example by the aid of a barometer. The accuracy of the measurement is thereby increased.

In another advantageous embodiment of the measuring method, the optical signal is transmitted and evaluated in real time. Accordingly, the optical signal comprises signals from the optical indicator and the sensor system for temperature recording. Thus, a quality check is feasible on each packaging procedure.

Further features, details and advantages of the present invention result from the wording of the claims as well as from the description of practical examples based upon figures.

The present invention is further elucidated in more details based on the following text with reference to preferred practical examples based upon the relevant figures, where:

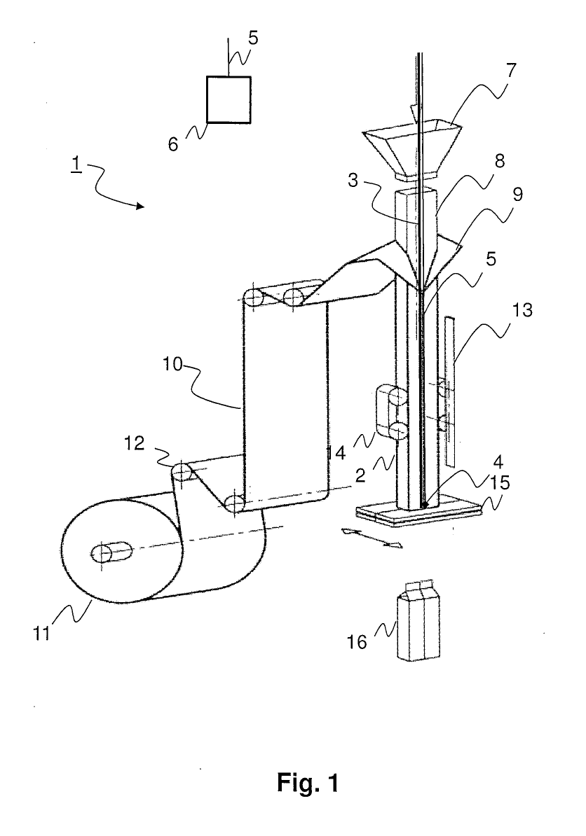

FIG. 1: is a schematic representation of a tubular bag packaging machine with a horizontal forming, filling, and sealing system, and

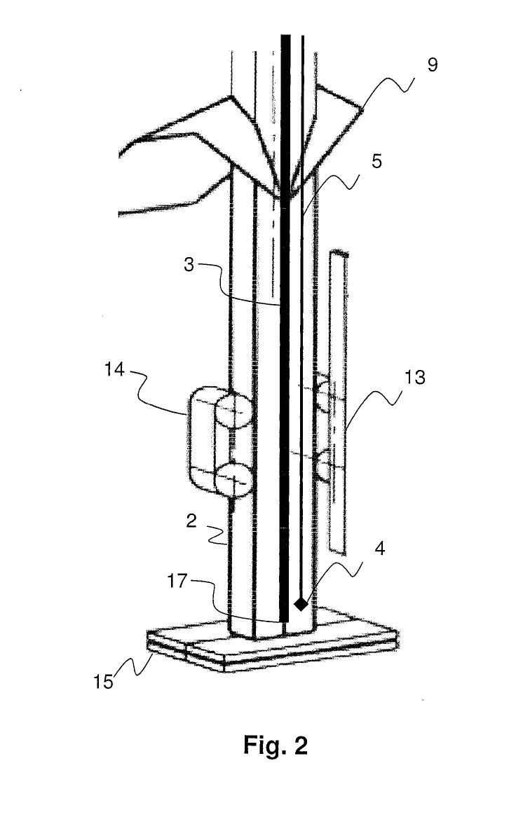

FIG. 2: is a detail view of a tubular bag packaging machine with a gas lance, a light conductor, and an indicator.

The reference numbers and their meaning are summarized in the list of reference numbers. In general, equal reference numbers describe equal parts.

FIG. 1 in a schematic view shows a tubular bag packaging machine 1 with a horizontal forming, filling, and sealing system. Accordingly, it is envisaged to determine a concentration of at least one gas within a package 2 to be sealed. The gas is introduced through a gas lance 3 into the package 2 to be sealed. To determine the concentration, the invention provides for an indicator 4 molded to a light conductor 5 and transmitting an optical signal to an evaluation unit 6.

In the illustrated embodiment, the goods to be packed are introduced via a filling hopper 7 into a filling tube 8. The filling tube 8 protrudes into a molded shoulder 9 via which a foil 10 is applied onto filling tube 8. Foil 10 is conveyed from a reservoir roll 11 via an unrolling device 12 onto the molded shoulder 9.

On the filling tube 8, the foil 10 constitutes the package 2 to be sealed, with a longitudinal seam sealing 13 sealing the foil 8 in advance and forming a tubular bag. The tubular bag is unrolled via a feed-forward device 14 from the filling tube 8 and passed on.

The gas lance 3 protrudes to a point shortly in front of a transverse sealing 15, which seals the package 2 to be sealed in transverse direction and separates it from the tubular bag. Located downstream of the transverse sealing 15 is a finish packaging 16 of the goods to be packed, being ready for ongoing transportation or storage.

The gas introduced into the package serves for increasing the durability of the goods to be packed. Accordingly, the introduced gas displaces the normal ambient air and thus reduces, for example, the oxygen content within the package 2 to be sealed.

To ensure durability of the goods packed, the concentration of the gas within the package 2 to be sealed must be monitored. For determination of the concentration, the present invention provides for an indicator 4 which is molded to the light conductor 5 and which transmits an optical signal to the evaluation unit 6. The indicator 4 is molded from a fluorescent material, preferably from a polymer material. The indicator material contains substances which cause fluorescence, with the spectrum of fluorescence being dependent upon the chemical composition of the gas surrounding the indicator 4.

FIG. 2 in a detail view shows the tubular bag packaging machine 1 with the gas lance 3, indicator 4, and light conductor 5. In this embodiment, indicator 4 is not conducted up to the gas outlet 17 of gas lance 3 in order to ensure that in fact the gas existing in the package 2 to be sealed and, respectively, in the tubular bag rather than the gas streaming out from the gas lance 3 is analyzed with regard to the gas to be determined.

### LIST OF REFERENCE NUMBERS

1 Tubular bag packaging machine

2 Package

3 Gas lance

4 Indicator

5 Light conductor

6 Evaluation unit

7 Filling hopper

8 Filling tube

9 Molded shoulder

10 Foil

11 Reservoir roll

12 Unrolling device

13 Longitudinal seam sealing

14 Feed-forward device

15 Transverse seam sealing

16 Finish packaging

17 Gas outlet

1. Measuring device, more particularly for a tubular bag packaging machine (1), to determine the concentration of at least one gas within a package (2) to be sealed, wherein it is possible to introduce a protective gas via a gas lance (3) into the package (2) to be sealed, characterized in that, the measuring device comprises an indicator (4), a light conductor (5), and an evaluation unit (6), wherein the indicator (4) is comprised of a fluorescent material, preferably a polymer material and arranged at the end of the light conductor (5) and within the package (2) to be sealed, wherein the evaluation unit (6) takes-up and evaluates an optical signal from the indicator (4) via the light conductor (5) to determine the concentration of the at least one gas.

2. Measuring device according to claim 1, characterized in that the indicator (4) is subdivided into ranges, each range being sensitive to a certain concentration of a gas or to a concentration of a certain gas.

3. Measuring device according to any of the preceding claim 1 or 2, characterized in that the indicator (4) produces fluorescence at a pre-defined partial pressure of the gas to be determined and/or reflects and/or transmits light in a certain range.

4. Measuring device according to any of the preceding claim 1, 2, or 3, characterized in that the indicator (4) is of a flat shape.

5. Measuring device according to any of the preceding claims 1 to 4, characterized in that the indicator (4) is molded in a form-locking manner to the light conductor (5).

6. Measuring device according to any of the preceding claims 1 to 5, characterized in that the light conductor (5) is guided along the gas lance (3) into the package (2) to be sealed.

7. Measuring device according to any of the preceding claims 1 to 6, characterized in that the light conductor (5) and the indicator (4) is guided up to a transverse sealing zone of the package (2) to be sealed.

8. Measuring device according to any of the preceding claims 1 to 7, characterized in that a sensor system for temperature recording is provided for.

9. Measuring device according to claim 8, characterized in that the sensor system for temperature recording comprises a fluorescent substance.

10. Measuring method, more particularly for a tubular bag packaging machine (1), to determine the concentration of at least one gas within a package (2) to be sealed, according to which a protective gas is introduced via a gas lance (3) into the package (2) to be sealed, characterized in that the gas concentration is indicated via an indicator (4), wherein a light conductor (5) is guided into the package (2) to be sealed and wherein an optical signal from the indicator (4) is transmitted via the light conductor (5) to an evaluation unit (6), wherein the package (2) to be sealed is sealed, preferably welded, immediately upon transmission of the signal.

11. Measuring method according to claim 10, characterized in that the evaluation unit (6) determines the concentration of the gas from the reflectivity, transmissivity and/or fluorescence of the indicator (4) in a certain optical signal range.

12. Measuring method according to claim 10 or 11, characterized in that the concentration of oxygen, nitrogen, carbon dioxide and/or a gas mixture is determined.

13. Measuring method according to any of the preceding claims 10 to 12, characterized in that an ambient pressure is determined and utilized for signal compensation.

14. Measuring method according to any of the preceding claims 9 to 12, characterized in that the optical signal is transmitted and evaluated in real time.
